(19) United States
(12) Patent Application Publication
(10) Pub. No.: US 2006/0260174 A1
(43) Pub. Date: Nov. 23, 2006

(54) Rod holder

(76) Inventors: Dale Crowe, Easley, SC (US); Heath Burditt, Starr, SC (US)

Correspondence Address: J. BENNETT MULLINAX, LLC, P. O. BOX 26029, GREENVILLE, SC, 29616-1029, US

(21) Appl. No.: 11/133,687

(22) Filed: May 20, 2005

(51) Int. Cl. A01K 97/10

(52) U.S. Cl. 43/21.2

(57) ABSTRACT

A holder for a fishing rod, rifle, or other generally axially shaped member is provided in which an article rests within a sleeve. Along one end of the sleeve a curved locking member is provided which is adapted for placement over a secured article. A second curved member is positioned within the sleeve and beneath a secured article. The respective curved members are connected to a common hinge and move in tandem. The secured article can be removed by lifting the article above the sleeve and thereby moving the curved engagement members in unison to a release position.

### FIELD OF THE INVENTION

This invention is directed towards a quick release holder suitable for use with a fishing rod, a bow, a rifle or shotgun, or similar article.

### BACKGROUND OF THE INVENTION

This invention relates to holders for fishing rods and other sporting equipment. There are a variety of holders known in the art which include tubular holders into which a rod may be inserted. Holders of this type may be seen in reference to U.S. Pat. No. D503,768, incorporated herein by reference. Such holders use an angled position relative to a horizontal reference plane to keep the rod inside the holder.

Other types of holders use a slot or tab to help secure a handle of a reel within the holder to minimize the risk that a rod may be pulled from the holder when the rod is placed under tension from a fish or an underwater obstruction. One such holder is seen in reference to U.S. Pat. No. 6,862,835 and which is incorporated herein by reference. One disadvantage of holders having this type of securing arrangement is that the rod is difficult to remove from the holder when under tension from a fish. As such, it is difficult to grab the rod in order to set the hook. The delay in getting the rod to release from the rod holder results in fewer hooked fish.

There remains a need for a holder which securely fastens and retains a fishing rod at a variety of orientations relative to a horizontal reference plane. Further, there is a need for a secure holder which provides for a quick release of the rod from the holder when the rod is under tension. Accordingly, there remains room for improvement and variation within the art.

### SUMMARY OF THE INVENTION

It is one aspect of at least one of the present embodiments of the invention to provide for a quick release holder which can be used to securely retain a fishing rod, rifle, shot gun, archery bow, trolling motor shaft, or other similar article.

It is another aspect of at least one of the present embodiments to provide for a holder which, as a load on the held article increases, provides a proportional increased holding force on the article.

It is another aspect of at least one the present embodiments to provide for a holder which allows for the quick release of the held object even when the object is under a strain or load.

It is another object of at least aspect of one embodiment of the present invention to provide for a fishing rod holder comprising an arcuate sleeve having a bottom wall and a pair of oppositely spaced sidewalls, a hinge defined along an upper edge of one of the sidewalls, a tab member connected to the hinge along an edge of the tab member, the tab member further defining an arcuate shape having a curvature substantially similar to a curvature of the arcuate sleeve, and a locking member connected to the hinge along an edge of the locking member, the locking member adapted for positioning over a top of the sleeve, wherein when the tab member is positioned in proximity to the bottom wall, the locking member extends over a top of the sleeve, the locking member and the tab member moving in tandem about the hinge.

These and other features, aspects, and advantages of the present invention will become better understood with reference to the following description and appended claims.

### BRIEF DESCRIPTION OF THE DRAWINGS

A fully enabling disclosure of the present invention, including the best mode thereof to one of ordinary skill in the art, is set forth more particularly in the remainder of the specification, including reference to the accompanying drawings.

FIG. 1A is a side perspective view of one embodiment of a quick release holder of the present invention.

FIG. 1B is a separate view of the pivoting portion of the quick release holder seen in reference to FIG. 1A.

FIG. 2 is a perspective view of the embodiment seen in FIG. 1A in which the pivoting tab and locking members are shown in a first engaging position.

FIGS. 3A and 3B are side views of the embodiment seen in FIG. 1A and illustrate placement of an article within the holder.

FIGS. 4 and 5 are sectional views as taken along the respective lines 4-4 and 5-5 as seen in reference to FIG. 3B.

### DESCRIPTION OF THE PREFERRED EMBODIMENT

Reference will now be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents. Other objects, features, and aspects of the present invention are disclosed in the following detailed description. It is to be understood by one of ordinary skill in the art that the present discussion is a description of exemplary embodiments only and is not intended as limiting the broader aspects of the present invention, which broader aspects are embodied in the exemplary constructions.

In describing the various figures herein, the same reference numbers are used throughout to describe the same material, apparatus, or process pathway. To avoid redundancy, detailed descriptions of much of the apparatus once described in relation to a figure is not repeated in the descriptions of subsequent figures, although such apparatus or process is labeled with the same reference numbers.

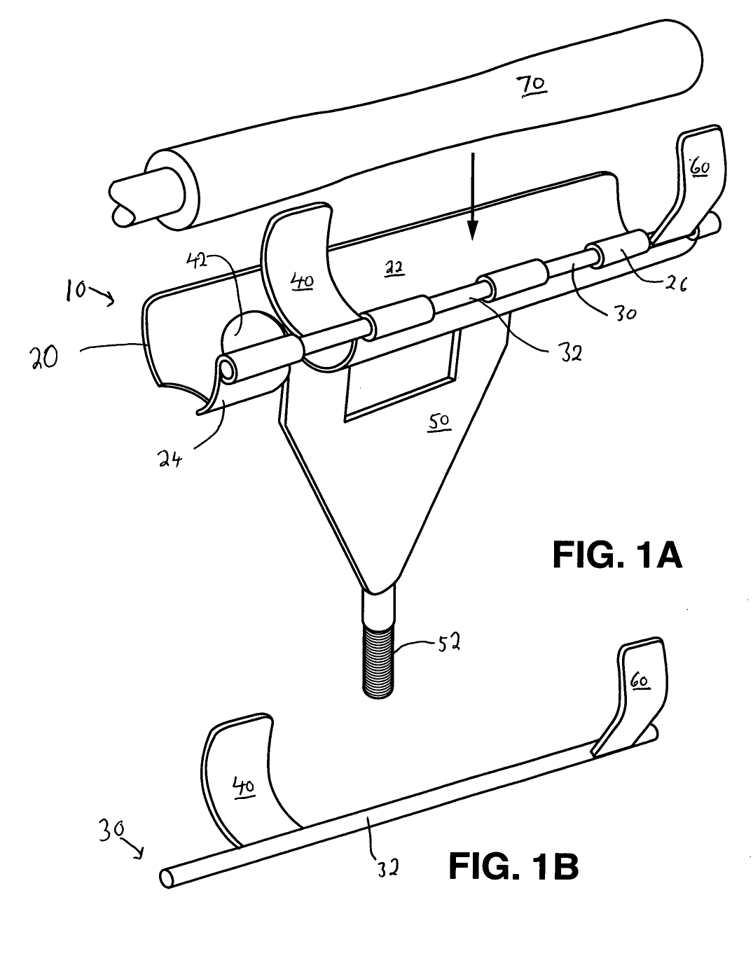

As seen in reference to FIG. 1A, a holder 10 is illustrated which has an arcuate sleeve 20 having an inner surface 22 and an outer surface 24. An upper edge of sleeve 20 supports a hinge 30 defined by a pin 32 which is retained within a rolled edge 26 of an upper edge of sleeve 20. As seen in reference to FIG. 1A, rolled edge 26 may be formed by discontinuous portions of the upper sleeve edge. The resulting arrangement of the hinge allows pin 32 to rotate within rolled edge 26. A tab member 40 is connected to pin 32 of hinge 30. Tab member 40 may have an arcuate shape similar to the curvature, dimensions, and orientation of sleeve 20. As illustrated, tab member 40 may be positioned opposite a corresponding opening 42 defined by sleeve 20 and which allows the tab member 40 to be positioned substantially flush with the inner surface 22 of sleeve 20.

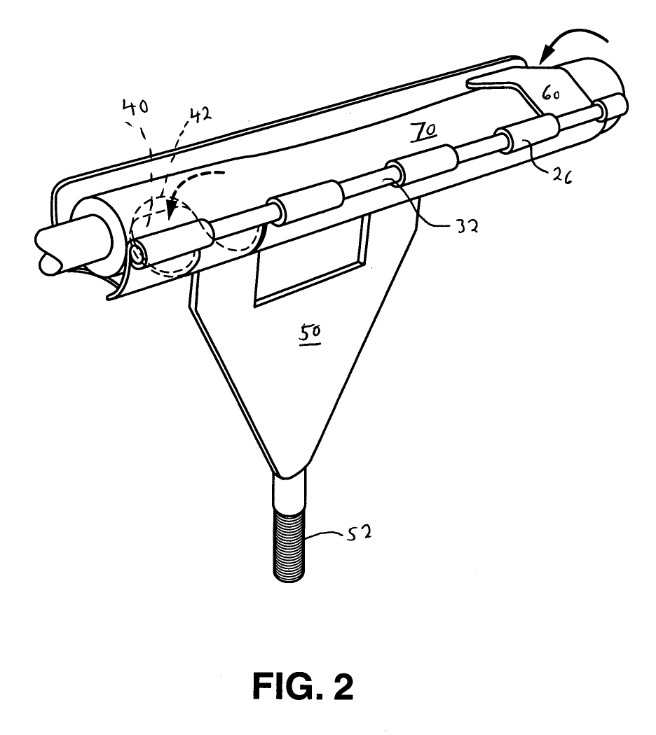

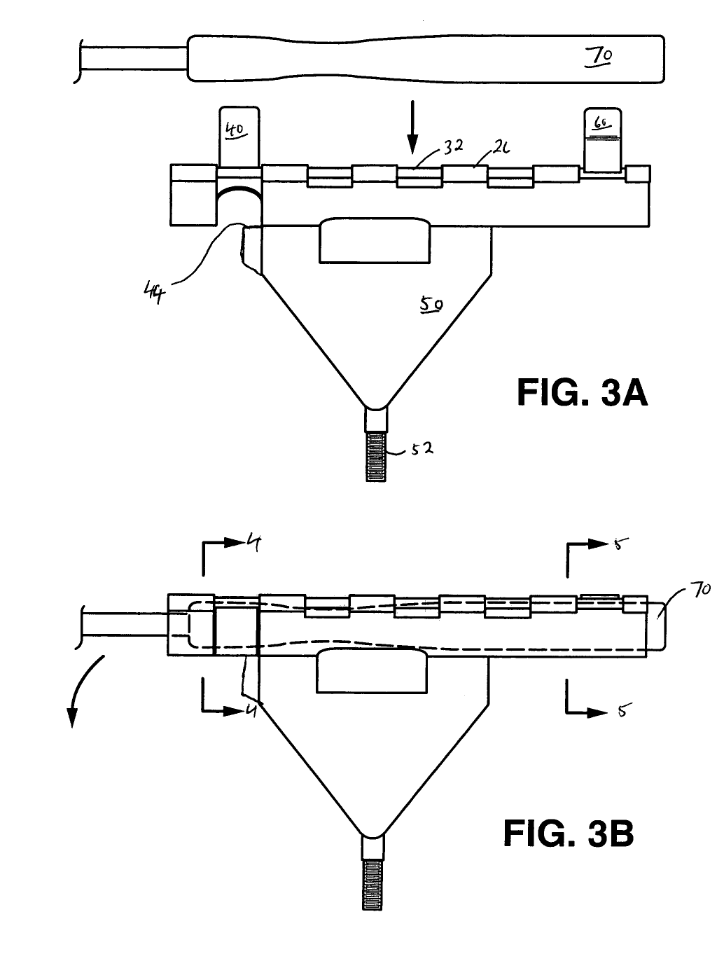

As seen in reference to FIGS. 1A and 2, tab member 40 may be pivoted from a first position within the sleeve 20, to a second position in which tab member 40 is rotated along hinge 30 to a position outside the sleeve. An optional stop member 44 (FIG. 3A) may be positioned beneath the opening 42. In the illustrated embodiment, the stop member 44 may be provided by an edge wall of a bracket 50, bracket 50 secured to the outer surface 24 and providing an attachment mechanism, seen here as a threaded rod member 52 which can be used to secure the holder to a mated threaded receptacle. A locking member 60 is also connected to pin 32 of hinge 30. Locking member 60 has, as shown in the illustrated embodiment, a curvature which serves to enclose a portion of the arcuate sleeve 20 when in a first secured position. Locking member 60 and tab member 40 move in tandem relative to the hinge 30.

As seen in reference to FIG. 2, when the tab member 40 is in a first position within sleeve 20, locking member 60 defines a first position covering a portion of the arcuate sleeve 20. As either locking member 60 and/or tab member 40 are pivoted to a second position best seen in FIG. 1A, the arrangement of the locking member 60 and tab member 40 are such that an object held within arcuate sleeve 20 can easily be removed and/or inserted.

As seen in reference to FIGS. 1A and 3A, the locking member 60 and tab member 40 may be positioned within opposite halves of a length of sleeve 20 and more preferably positioned within a terminal 25 percent end portion of the respective sleeve ends.

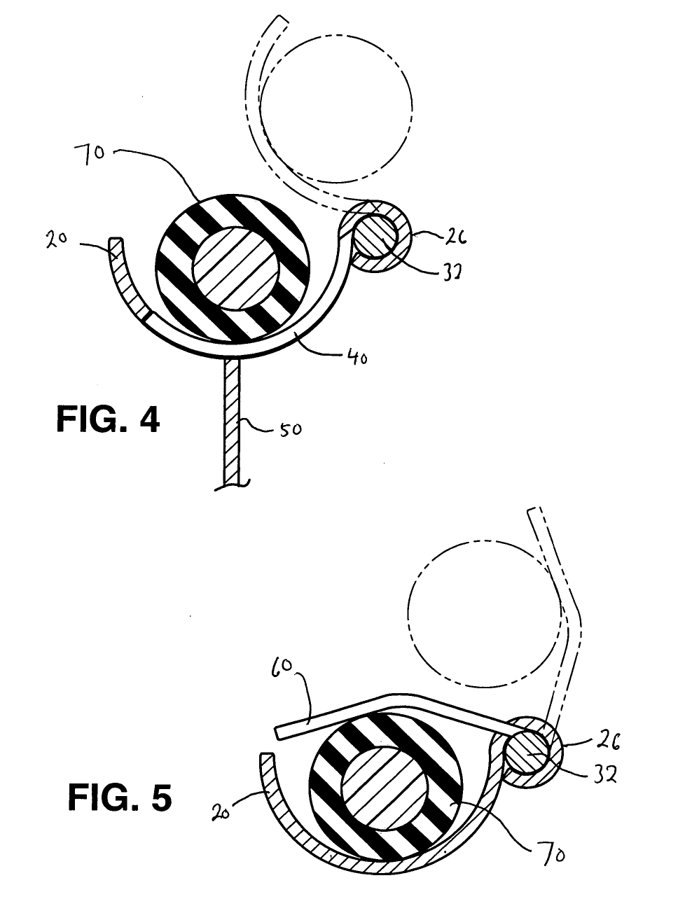

As seen in reference to FIG. 1A and FIG. 3A through FIG. 5, the holder 10 can be used to secure an object 70 seen here as a butt portion of a fishing rod. As seen in the Figures, the object 70 may be placed within the sleeve when the locking member 60 and tab member 40 are in a second position. Placement of the object 70 within the sleeve 20 as indicated by the directional arrow in FIG. 1A, will secure the object 70 within the holder as seen in reference for FIG. 2. Alternatively, the rod may be inserted axially from a front of the holder to a rear of the holder while the tab member 40 and locking member 60 are in a first position. As illustrated, locking member 60 is placed in operative engagement over a butt portion of a fishing rod. At the same time, tab member 40 is positioned beneath the rod. The weight of the object 70 provides a sufficient leverage force against either the locking member 60 or the front edge of sleeve 20 to interengage the locking member 60 and tab member 40 around the inserted rod.

In further reference to FIG. 2, tension placed on the object 70 by the object's weight/leverage, gravity, a strike, trolling resistance, an obstruction, or other similar event tends to interengage the curved surface of tab member 40/locking member 60 against the respective lower surface or upper surface of object 70. The force applied by object 70 to either locking member 60 or to tab member 40 is translated along hinge 30 to the respective locking member 60 or tab member 40. Accordingly, tension from object 70 is exerted upwardly against tab member 40 and via locking member 60 downwardly against the object 70. In other words, downward pressure by object 70 against tab member 40 supplies an opposing and proportional pressure against the object 70 which is supplied by the overhead locking member 60. Since tab member 40 and locking member 60 move in tandem relative to hinge 30, as a force is applied relative to tab member 40, a corresponding counter force is applied to an object 70 by the locking member 60 thereby preventing the hinge 30 from opening. It is understood and appreciated that the pressure between the object 70 and tab member 40 may be initiated by the interaction of an upper surface of object 70 against the overhead locking member 60. In either event, the principle of operation remains the same in that the force applied against one of either the tab member 40 or locking member 60 is applied in an opposing direction against the object 70 by the corresponding locking member 60/tab member 40. As a result, the rod pressure or weight generates opposing forces within the holder 10 such that object 70 is held in a tension relationship between locking member 60 providing a downward force and tab member 40 supplying an upward force. Through the hinged arrangement of tab member 40 and locking member 60, object 70 is securely held in place. The opposing forces between the respective locking member 60 and tab member 40 secures object 70 within the holder 10.

The use of a hinge 30 to interconnect the tab member 40 and locking member 60 has additional advantages with respect to a holder. Unlike many prior art holder designs, the holder 10 provides for a simple release mechanism which can be used, irrespective of the amount of tension or load a fishing rod or similar object may be exerted upon it. By simply grasping the butt of the rod and lifting the rod away from the arcuate sleeve in an upward movement, the locking member 60 and tab member 40 moves in tandem and releases the rod. By removing the rod in this manner, pressure against tab member 40 is removed, permitting the tab member 40 and locking member 60 to be freely pivoted to the second position whereupon the rod or similar object may be lifted free from the holder.

The holder 10 may be constructed of a variety of suitable materials. For instance, stainless steel may be a useful material for marine applications in that it is resistant to corrosion and can withstand the forces which may be generated from large salt water fish species. In the illustrated embodiment, the threaded rod member 52 can be used to engage a mated receptacle which may be present on a boat or pier. In addition, any number of other conventional attachment mechanisms can be used to reversibly secure the holder 10 to a boat, dock, pier, or similar structure.

While the above description is given in reference to a holder for a fishing rod, holder 10 also has utility with a variety of other outdoor and recreational objects. By making variations in the size and dimensions of sleeve 20, a holder 10 may be provided which may be used to secure a rifle, hand gun, shot gun, archery bow, trolling motor, or similar article. A holder 10 can also be used as part of a storage or organizing system in a garage or utility shed which allows rods, bows, golf clubs, hand tools, bicycle frames, and other objects having cylindrical type handles, tubing, or parts to be securely stored and to be quickly released when needed.

For hunting and fishing applications, the holder may be suitably covered with a rubberized or plastic coating to reduce noise and provide a less visible, camouflaged appearance. The contact surfaces of the holder which engage an article can also be provided with protective padding so as to protect the finish of a rifle, bow, or other article placed within the holder.

It is also envisioned that the holder 10 may be mounted on a swivel type attachment such as a repositionable plate or a ball and socket type joint which allows the angle of the holder to be varied relative to either bracket 50 or rod member 52. In this manner, the angle of the rod or similar article can be varied. For instance, when used as a rod holder, it is often desirable to position the rod tip at a certain angle for trolling or to be able to position multiple rods in respective holders a spaced distance apart for multiple trolling lines. Further, an angled adjustment of the holder relative to a securing bracket or attachment mechanism allows convenient placement of rod, rifle, or other article relative to its user. As a general rule, a horizontal orientation or greater angle relative to a horizontal reference plane is preferred in that the weight of the article resting within the holder will provide the necessary securing forces against tab member 40 and locking member 60 to keep the article from slipping from the holder.

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention which is set forth in the following claims. In addition, it should be understood that aspects of the various embodiments may be interchanged, both in whole, or in part. Therefore, the spirit and scope of the appended claims should not be limited to the description of the preferred versions contained therein.

That which is claimed:

1. A fishing rod holder comprising:
an arcuate sleeve having a bottom wall and a pair of oppositely spaced sidewalls;
a hinge defined along an upper edge of one of said sidewalls;
a tab member connected to said hinge along an edge of said tab members, said tab member further defining an arcuate shape having a curvature substantially similar to a curvature of said arcuate sleeve;
a locking member connected to said hinge along an edge of said locking member, said locking member adapted for positioning over a top of said sleeve;
wherein when said tab member is positioned in proximity to said bottom wall, said locking member extends over a top of said sleeve, said locking member and said tab member moving in tandem about said hinge.

2. The fishing rod holder according to claim 1 wherein said holder further comprises a support bracket positioned on an exterior wall of said arcuate sleeve.

3. The fishing rod holder according to claim 1 wherein said sleeve defines an opening positioned opposite said tab member.

4. The fishing rod holder according to claim 1 wherein a stop member is defined beneath said opening, said stop member engaging said tab member when said tab member is positioned within said sleeve opening.

5. The fishing rod holder according to claim 1 wherein said tab is positioned along a front half of said sleeve and said locking member is positioned along a rear half of said sleeve.

6. The fishing rod according to claim 1 wherein said tab member is positioned along a terminal 25 percent of a front portion of said sleeve and said locking member is positioned along a terminal 25 percent portion of said sleeve.

7. A holder for an object comprising:
an arcuate sleeve having a bottom wall and a pair of oppositely spaced sidewalls;
a hinge defined along an upper edge of one of said sidewalls;
a tab member connected to said hinge along an edge of said tab members, said tab member further defining an arcuate shape having a curvature substantially similar to a curvature of said arcuate sleeve;
a locking member connected to said hinge along an edge of said locking member, said locking member adapted for positioning over a top of said sleeve;
wherein when said object is placed within said arcuate sleeve, pressure exerted by the object against said tab member maintains pressure against the object by the locking member, thereby securing said object within said holder.

8. A process for securing an object within a holder comprising the steps of:
providing an arcuate sleeve having a bottom wall and a pair of oppositely spaced sidewalls, a hinge defined along an upper edge of one of said sidewalls, a tab member connected to said hinge along an edge of said tab members, said tab member further defining an arcuate shape having a curvature substantially similar to a curvature of said arcuate sleeve, and a locking member connected to said hinge along an edge of said locking member, said locking member adapted for positioning over a top of said sleeve;
inserting an object within said arcuate sleeve, said object positioned above said tab member and below said locking member;
applying tension to the object such that said tab member engages a portion of said object, said engaging force simultaneously applying a corresponding downward force by said locking member against said object, thereby securing said object between the opposing forces of said tab member and said locking member.
